(19) United States
(12) Patent Application Publication
(10) Pub. No.: US 2026/0004506 A1
(43) Pub. Date: Jan. 1, 2026

(54) IMPLIED MESH TOPOLOGIES IN DENSE GEOMETRY FORMAT ENCODING

(71) Applicant: Advanced Micro Devices, Inc., Santa Clara, CA (US)

(72) Inventors: David Kirk McAllister, Santa Clara, CA (US); Carsten Benthin, Munich (DE); Joshua David Barczak, Santa Clara, CA (US); Andrew Erin Kensler, Bellevue, WA (US); Mohammed Ahmed Muneam Al-Obaidi, Milton Keynes (GB)

(73) Assignee: Advanced Micro Devices, Inc., Santa Clara, CA (US)

(21) Appl. No.: 18/755,182

(22) Filed: Jun. 26, 2024

(51) Int. Cl. G06T 15/06

(52) U.S. Cl. CPC G06T 15/06

(57) ABSTRACT

A geometry compression format is described. The compression format eliminates the need to store duplicate vertex information by storing unique vertices in each compressed data structure. Different triangles can refer to the same vertex using an index value, which means that even if the same vertex is used multiple times in the compressed data structure, the entirety of the vertex information (e.g., positional information) does not need to be stored multiple times. While the format provides good compression characteristics, improvement can be gained by eliminating the indices and instead using an indication of an “implicit geometry.” The implicit geometry is a commonly-used geometry type that indicates a particular correspondence between unique vertices and triangles. In other words, by indicating an implicit geometry type, it is automatically known which vertices make up which triangles, and explicit index information does not need to be stored in the compressed data structure.

### BACKGROUND

In image synthesis, ray tracing is utilized to find a nearest intersection of a given ray with a scene where light propagation is simulated. Advances in ray tracing are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates the dense geometry format, according to an example;

FIG. 6 illustrates an example compressed data structure that includes topology information that does not include triangle elements, according to an example;

FIG. 7A illustrates a loop subdivision, according to an example;

FIG. 7B illustrates a loop subdivision having two subdivisions, rather than one, according to an example;

FIG. 8 illustrates a triangle grid subdivision, according to an example;

FIGS. 9A and 9B illustrate a Catmull-Clark subdivision, according to an example; and

FIG. 10 is a flow diagram of a method for processing a compressed data structure for storing geometry, according to an example.

### DETAILED DESCRIPTION

Dense geometry format is a compression format for geometry. The compression format stores geometry (e.g., primitives or triangles) in compressed data structures. The compression format eliminates the need to store duplicate vertex information by storing unique vertices in each compressed data structure. Triangles are represented in the format using list of references (“indices”) to the unique vertices. Different triangles refer to the same vertex using an index. Thus, even if the same vertex is used in different triangles represented by the compressed data structure, the compressed data structure does not need to store all information (e.g., positional information) for each vertex multiple times. Instead, by storing indices for the triangles, duplicated inclusion of vertex data is eliminated, since an index consumes much less data than the full data for each vertex.

While the format provides good compression characteristics, improvement can be gained by eliminating the indices and instead using an indication of an “implicit geometry.” The implicit geometry is a commonly-used geometry type that indicates a particular correspondence between unique vertices and triangles. In other words, by indicating an implicit geometry type, it is automatically known which vertices make up which triangles, and explicit index information does not need to be stored in the compressed data structure. The location of the vertices within the list of vertices specifies the connectivity of the vertices, without needing to store that information explicitly.

It should be understood that these implicit geometry types help improve the compression of geometry by providing more space for unique vertex information, since the indication of the implicit geometry consumes less data than the explicit index information. In addition, it is still possible to use compressed data blocks without implicit geometry (e.g., with explicit index information) in cases where the geometry does not match one of the implicit geometry types.

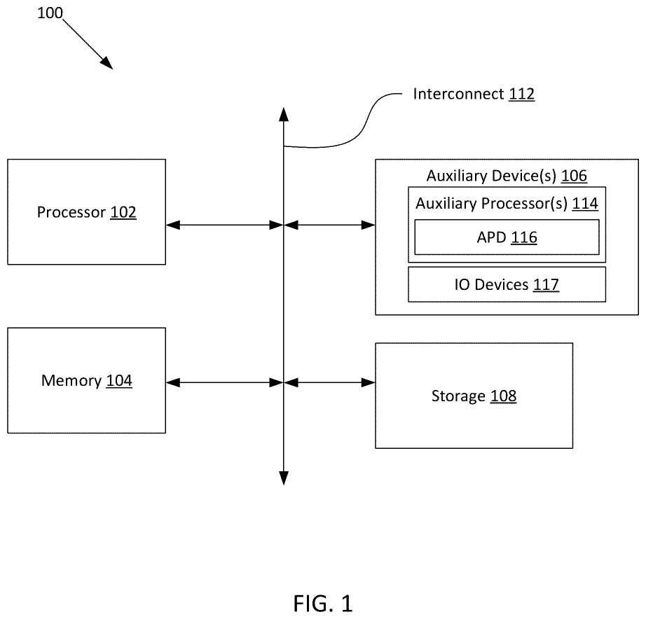

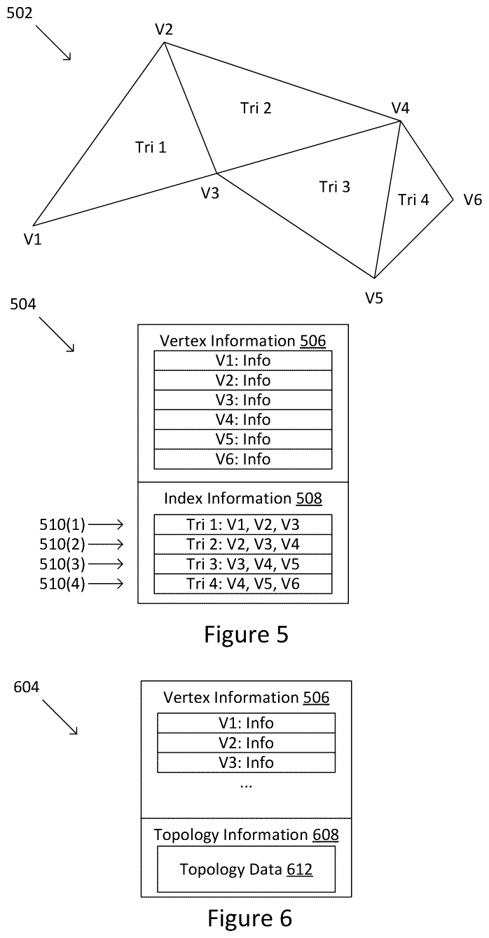

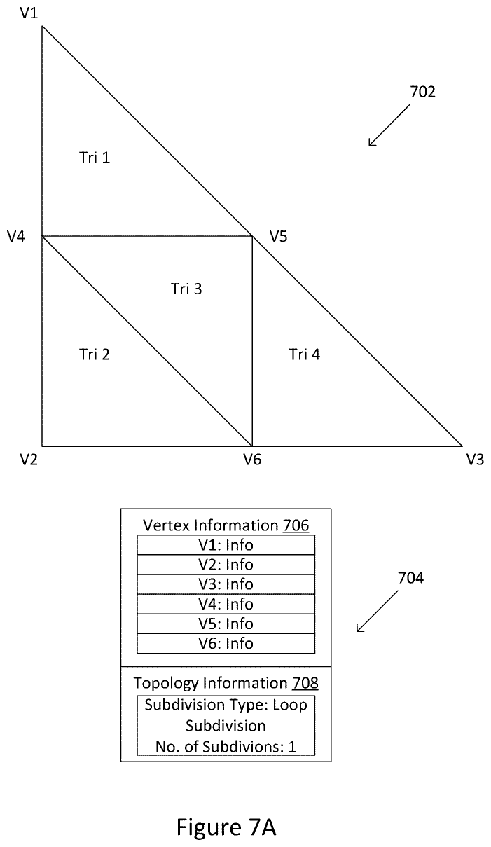

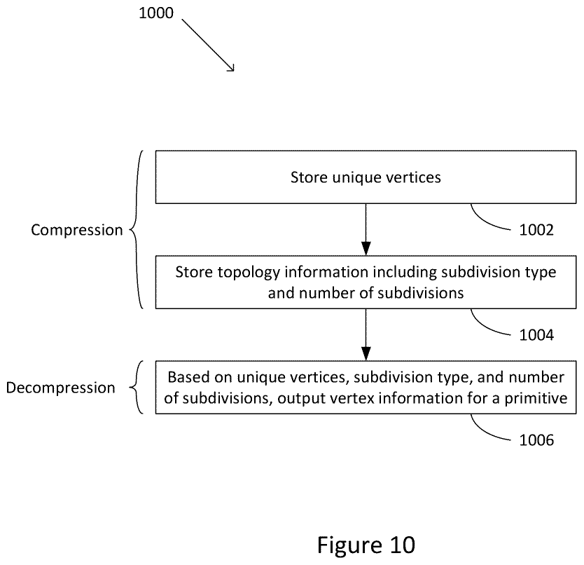

FIGS. 1-4 describe an example system in which the compression technique can be used. It should be understood that DGF is useful to compress the leaf nodes of BVHs. FIG. 5 describes the dense geometry format. For clarity, the use of a fixed-point format to provide additional compression is omitted in FIG. 5. FIGS. 6-9B describe examples of the dense geometry format with implicit geometry. FIG. 10 describes a method for performing compression and decompression operations for the dense geometry format with implicit geometry.

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with, for example, a single-instruction-multiple-data (“SIMD”) or a single-instruction-multiple-thread (“SIMT”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

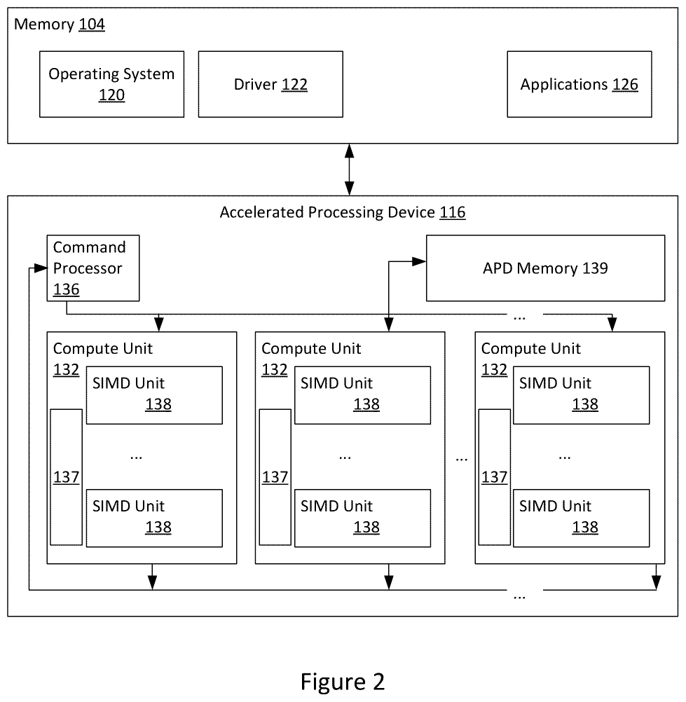

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some examples, the driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image based on commands received from the processor 102. The APD 116 also executes compute processing operations that are not directly related to graphics operations, such as operations related to video, physics simulations, computational fluid dynamics, neural computing, artificial intelligence (AI) tasks, or other tasks, based on commands received from the processor 102. In some examples, the APD 116 does not perform graphics operations.

In this example, the APD 116 includes compute units 132 that include one or more SIMD units 138 that perform operations at the request of the processor 102 in a parallel manner according to a SIMD paradigm. The compute units 132 are sometimes referred to as “parallel processing units” herein. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations as well as various compute or AI operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

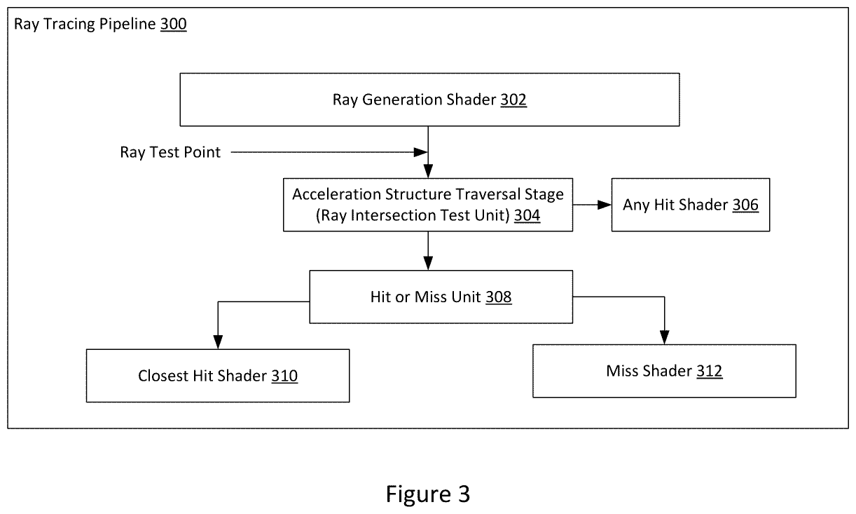

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

Any portion of the ray tracing pipeline 300 is implemented as software, hardware (e.g., circuitry such as a programmable or non-programmable processor, of fixed function circuitry) or a combination thereof, and can be implemented partially or fully on the APD 116. In various such examples, the software executes on the SIMD units 138 and/or on a different processor. More specifically, the various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle or procedural primitive and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. Another use is to spawn additional rays for reflections and/or global illumination effects. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader. In some examples, rendering a scene involves casting at least one ray for each of a plurality of pixels of an image to obtain colors for each pixel. In some examples, multiple rays are cast for each pixel to obtain multiple colors per pixel for a multi-sample render target. In some such examples, at some later time, the multi-sample render target is compressed through color blending to obtain a single-sample image for display or further processing. While it is possible to obtain multiple samples per pixel by casting multiple rays per pixel, techniques are provided herein for obtaining multiple samples per ray so that multiple samples are obtained per pixel by casting only one ray. It is possible to perform such a task multiple times to obtain additional samples per pixel. More specifically, it is possible to cast multiple rays per pixel and to obtain multiple samples per ray such that the total number of samples obtained per pixel is the number of samples per ray multiplied by the number of rays per pixel.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

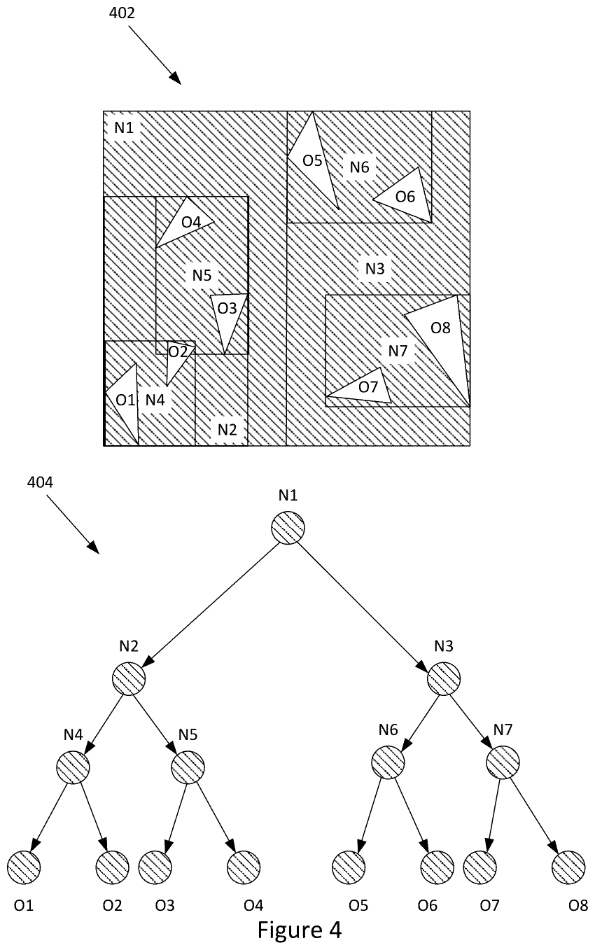

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that No succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

Geometry data of the leaf nodes can be compressed, which improves the memory or storage utilization and transfer bandwidth characteristics of the BVH. As described above, the leaf nodes of the BVH refer to primitives that can be rendered. It is possible that a leaf node refers to a compressed data structure that stores data for one or more primitives. More specifically, the compressed data structure includes information that specifies one or more triangles, and each leaf node of the BVH of FIG. 4 refers to one of the triangles in such a compressed data structure. To use such a compressed data structure, an device (e.g., device 100) compresses geometry into such compressed data structures. A BVH builder (e.g., software, hardware (such as circuitry), or a combination thereof) builds a BVH where the leaf nodes reference primitives in the compressed data structure. At render time, the ray tracing pipeline 400 arrives at a leaf node which specifies a triangle of a compressed data structure. The ray tracing pipeline 400 decompresses the compressed data structure to obtain an uncompressed primitive and performs operations for that primitive such as performing an intersection test or performing shading based on an intersected primitive. It should be understood that any particular compressed data structure can be referenced by one or multiple leaf nodes. Each leaf node would identify which primitive of the compressed data structure is associated with that leaf node and the decompression thus obtains the primitive data for that identified primitive when necessary.

FIG. 5 is a diagram illustrating aspects of a compressed data structure for storing primitive information, according to an example. FIG. 5 illustrates a set of triangles 502 and a compressed data structure 504 representing the set of triangles 502. The set of triangles 502 includes triangle 1, triangle 2, triangle 3, and triangle 4. Triangle 1 is composed of vertices V1, V2, and V3. Triangle 2 is composed of vertices V2, V3, and V4. Triangle 3 is composed of vertices V3, V4, and V5. Triangle 4 is composed of vertices V4, V5, and V6. In FIG. 5 (and elsewhere herein), triangles are labeled “tri X” (where X is a number).

The compressed data structure 504 includes information for these triangles. Specifically, the compressed data structure 504 includes vertex information 506 and index information 508. The vertex information 506 includes actual information about vertices, such as position information, and geometry and object identifiers. The index information 508, which is also sometimes referred to as “topology information” herein, indicates which vertices of the vertex information 506 make up the triangles represented by the compressed data structure 504. More specifically, the index information 508 includes triangle elements 510, each of which includes reference to vertices of the vertex information 506. In other words, each triangle element 510 includes a reference to a set of vertices, where that set of vertices together comprises a triangle.

In addition to the above, it is possible to represent all positional information for the vertices of the vertex information 506 in a fixed-point number space, rather than as floating-point numbers. The fixed-point number space is a “virtual grid” in which every increment of a number in the space has the same difference (rather than with floating point numbers, where the difference between adjacent representable values varies with the magnitude of the number). The fixed-point number space allows for a smaller number of bits to be used (e.g., 16 instead of 32) to represent the coordinate values for the vertices. In some examples, the vertex information 506 also includes a minimum and maximum value for all vertices in the vertex information 506, so that the fixed-point numbers, interpreted in light of these minimum and maximum values, are able to represent a large number of possible number within the range given by the minimum and maximum value.

As can be seen, the triangles in a compressed data structure 504 are represented in FIG. 5 with a set of vertex information 506 and a set of index information 508. The full set of information (e.g., parameters such as coordinates, material ID, or the like) for each vertex is included only once in each compressed data structure 504. For vertices used in multiple triangles, this information is effectively “de-duplicated” by referring to such vertices by reference in the triangle elements 510. While some benefit is gained from such compression, additional benefit can be gained where a compressed data structure 504 represents topology that is regular.

FIG. 6 illustrates an example compressed data structure 604 that includes topology information 608 that does not include triangle elements 510, according to an example. The compressed data structure 604 of FIG. 6 is similar to the compressed data structure 504 of FIG. 5. However, instead of including the triangle elements 510 that include explicit lists of vertex references, the compressed data structure 604 includes topology information 608 which includes topology data 612. The topology data includes information that indicates which triangles are formed by the vertices of the vertex information 506. More specifically, the triangles are defined based on the topology data 612 and the vertex information.

The topology data 612 indicates how to interpret the vertex information. More specifically, for any given set of topology data 612, a particular set of triangles is defined based on the order of the vertices within the vertex information 506. In an example, the topology data 612 indicates that each set of three consecutive vertices in the vertex information 506 forms a triangle. In such an example, the three vertices starting with V0 (e.g., V0, V1, V2) form a first triangle. Then the three vertices starting with V1 (e.g., V1, V2, V3) form a triangle, and so on. Another set of topology data 612 would indicate that different groups of vertices form triangles, and so on.

The topology data 612 includes an indication of a “subdivision,” which is a pattern of triangles. The indication of the subdivision indicates how to interpret the vertices as triangles, given the order of the triangles. A “subdivision” means a subdivision of base geometry, which indicates the pattern of triangles generated from a set of vertices. In an example, the subdivision indicates a “loop” based subdivision of a triangle, where subsequent vertices are part of increasingly smaller triangles that subdivide larger triangles. In another example, the subdivision indicates a grid-based triangle or quad, where the vertices define a column-by-column and row-by-row set of vertices. In another example, the subdivision indicates a Catmull-Clark-based subdivision, described in further detail herein. Although some example subdivisions are described, it should be understood that a variety of subdivisions are possible. In general, it should be understood that the topology information 608 allows triangles to be specified without explicit vertex references as in FIG. 5. Thus, for example, a single subdivision selection that may take only a small amount of data (e.g., only one byte) can replace all of the vertex references of the triangle elements 510 illustrated in FIG. 5. In addition to the above, a number of subdivisions is also stored, and this number of subdivision further describes the implicit geometry represented by a compressed data structure, as described elsewhere herein.

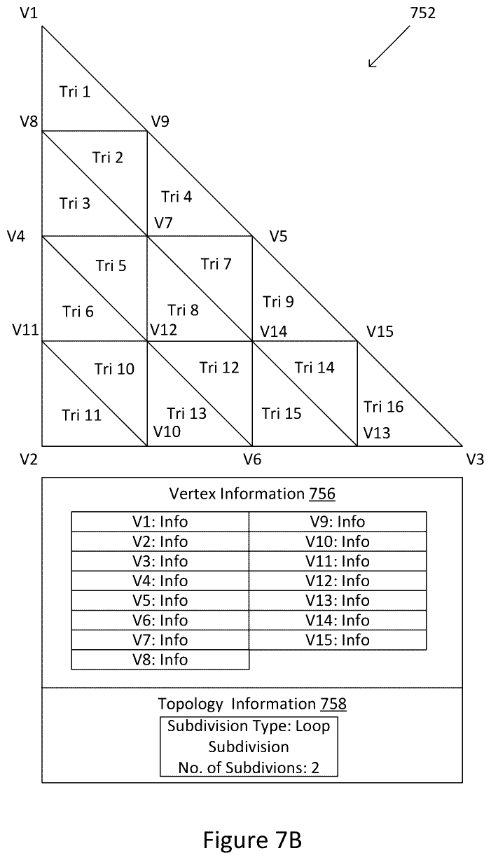

FIG. 7A illustrates a loop subdivision, according to an example. Subdivided triangle 702 is shown and a corresponding compressed data structure 704 with vertex information 706 and topology information 708 is shown.

In the loop subdivision, subsequent sets of vertices define triangles of increasingly smaller size. The size of the smallest triangle in such a subdivision is defined by the number of subdivisions. In the example illustrated, a first set of three vertices (V1, V2, V3) forms a large triangle. The next set of three vertices (V4, V5, V6) subdivides this larger triangle into four smaller triangles (tri 1, tri 2, tri 3, tri 4). Note that the smaller triangle (or more generally, the triangles formed by the smallest subdivisions) are the triangles actually represented by the compressed data structure 704, whereas the larger triangles are simply intermediate steps in the subdivision process.

The vertex information 706 includes position information for each of vertices V1-V6. The vertex information 706 also optionally includes other information such as other vertex parameters. The topology information 708 indicates that the compressed data structure 704 represents a loop subdivision with 1 subdivision. As a result of this topology information 708, the vertices are interpreted to comprise the triangles shown in FIG. 7A. More specifically, with six vertices, a topology type of “loop subdivision” and a number of subdivisions of “one” results in four triangles shown. A first triangle (tri 1) is formed from vertices V1, V4, and V5. A second triangle (tri 2) is formed from vertices V2, V4, and V6. Triangle tri 3 is formed from V4, V5, and V6, and triangle tri 4 is formed from V3, V5, and V6. As can be seen, the first three vertices V1, V2, and V3 form the larger triangle (the triangle of the base subdivision), and the subsequent vertices define subdivision of that triangle for a first subdivision. Each subdivision includes up to a number of triangles equal to the number of triangles in the previous level multiplied by 4, since the triangle subdivisions divide each triangle by 4. Thus, a first set of vertices in the vertex information 706 defines a triangle of a base subdivision, and a subsequent set of vertices defines the subdivisions for the first subdivision. In general, the base subdivision is defined with the first three vertices. Each subsequent subdivision is defined the number of unique vertices needed to represent the triangles of the subdivision. In some examples, it is this ordering of vertices in the vertex information 706 the defines the triangles. In other words, given a particular number of subdivisions represented by the compressed data structure 704 (as indicated by the topology information 708), the triangles represented by the compressed data structure 704 are represented by vertices that are organized in order of subdivision.

FIG. 7B illustrates a loop subdivision having two subdivisions, rather than one, according to an example. As can be seen, the two subdivisions results in the smallest triangles of FIG. 7A being subdivided a further time, into four triangles each. Thus, there are 16 triangles (4×4) in the subdivision 752 of FIG. 7B. In addition, there are more vertices in the vertex information 756, and these additional vertices represent the additional unique vertices required to represent the smaller triangles. In particular, the same vertices (V1-V6) correspond to the same larger triangles shown in FIG. 7A, and an additional 9 triangles (V7-V15) correspond to the smaller triangles of the second subdivision. In FIG. 7B, the topology information 758 indicates the same type of subdivision as in FIG. 7A, but indicates that there are two subdivisions rather than one. Thus, the additional vertices present as compared with FIG. 7A are interpreted as forming the triangles shown in the order shown. Again, each set of vertices in the vertex information 756 corresponds to a particular subdivision, as described above, and thus the order of the vertices in the vertex information 756 defines how triangles are formed from such vertices. Again, this is in contrast to the technique in FIG. 5, in which index information 508 explicitly lists the vertices in each triangle. With the topology information 608, such an explicit list is not needed.

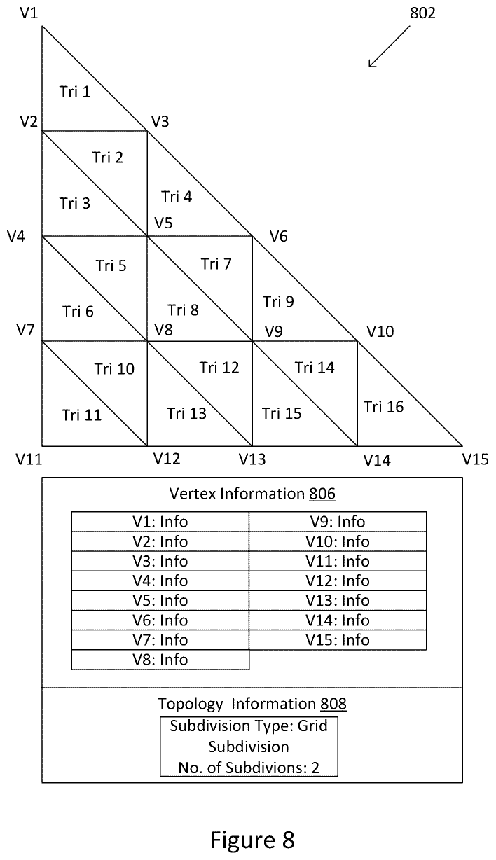

FIG. 8 illustrates a triangle grid subdivision 802, according to an example. The triangle grid subdivision 802 includes topology information 808 that specifies the triangle grid subdivision as well as two subdivisions. The vertex information 806 for the triangle grid subdivision 802 has vertex information for the 15 unique vertices V1-V15.

Note that in the grid subdivision, the triangles are formed from the vertices in a different way than in the loop subdivision of FIGS. 7A and 7B. More specifically, in the grid subdivision, the triangle is subdivided into a “grid” of triangles that includes a number of rows. In a first row at the top, there is one triangle defined by vertices V1-V3. In the next row, there are two more triangles (3) than the first row and the subsequent vertices V4-V6, in conjunction with vertices V2 and V3, define triangles for the second row. In the next row, there are two more triangles (5) and the subsequent vertices (V7-V10), in conjunction with vertices V4-V6 from the second row, define triangles for the third row. Finally, in the fourth row, vertices V11-V15, in conjunction with V7-V10, define five triangles. As can be seen, the ordering of vertices defines triangles in a grid order (e.g., column-by-column and then row-by-row, with sharing of vertices between rows), rather than in the loop subdivision order as described with respect to FIGS. 7A-7B.

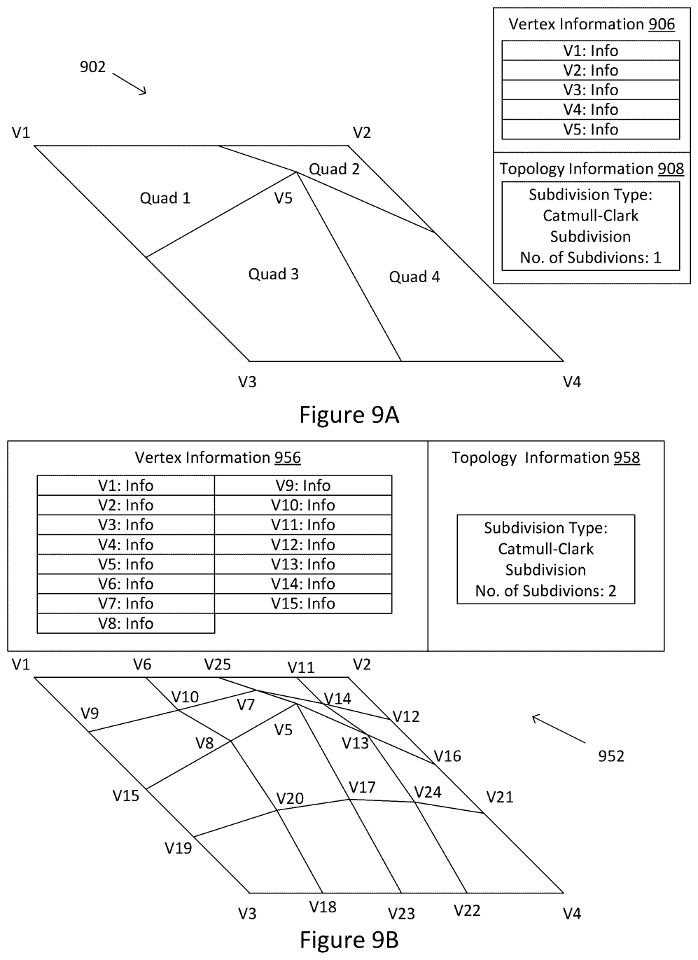

FIGS. 9A and 9B illustrate a Catmull-Clark subdivision, according to an example. FIG. 9A illustrates a Catmull-Clark subdivision 902 with one subdivision and FIG. 9B illustrates a Catmull-Clark subdivision 952 with two subdivisions.

In Catmull-Clark subdivision, a quad is subdivided by placing a vertex in the center of the quad and placing vertices at the midpoint of each edge of the quad. The center vertex then forms a new quad with each of the new midpoint edge vertices, thereby subdividing each quad into four quads. Further, the center vertex of a quad is displaced to some degree from the plane of the four vertices that form the quad. Repeated Catmull-Clark subdivision can result in curved shapes such as a sphere (if applied repeatedly to a shape such as a cube). In the Catmull-Clark subdivision 902 of FIG. 9A, there is one subdivision (see topology information 908). Thus, there are five vertices (see vertex information 906) and four quads. As with the other subdivision types, the order in which the vertices (rather than explicit indices) indicates which vertices form which quads. In the Catmull-Clark subdivision 952 of FIG. 9B, there are two subdivisions (see topology information 958), resulting in 16 quads and 25 vertices (see vertex information 956, though not all vertices are illustrated in 956).

Other subdivision types are possible. One example is a quad grid, where a base subdivision is a quad and each subdivision level subdivides each quad into four more quads. In this example, the vertices are ordered row-by-row and then column-by-column (in a similar manner as with the triangle-based grid subdivision).

As can be seen, the compression described herein allows for additional vertex information to be stored in a compressed data structure, as compared with the technique of FIG. 5, in which index information identifying vertices by reference is explicitly stored. More specifically, storing such a reference for each represented vertex consumes more space than the topology information stored in the compressed data structure that stores subdivision type and number of subdivision. For example, it is possible to represent the subdivision type as just one byte or even less information, and to represent the number of subdivisions as one byte or even less information, whereas the technique of FIG. 5 requires storing an item of data for each represented vertex (e.g., an index value, which can consume a whole byte for each such index value). While explicit index information can allow representation of arbitrary geometry, implicitly incorporating such information using the subdivision type and number of subdivisions allows identification of which vertices comprise which primitive for each primitive represented by the compressed data structure.

FIG. 10 is a flow diagram of a method 1000 for processing a compressed data structure for storing geometry, according to an example. Although described with respect to the systems described herein, those of skill in the art will understand that any system configured to perform the steps of the method 1000 in any technically feasible order falls within the scope of the present disclosure.

The method 1000 includes steps (1002, 1004) that are labeled compression and a step (1006) that is labeled decompression. In various examples, each of the compression and the decompression are performed by one or more processors. More particular any such processor could be a programmable processor, fixed function processor, application-specific integrated circuit, fixed function analog circuit, a programmable logic device, field programmable gate array, or any other type of circuitry programmed or configured to perform the operations described herein. In some examples, the one or more processors that performs decompression is different than the one or more processors that performs compression. In other examples, one or more of the processors that perform decompression is different than one or more of the processors that perform compression. The term “compressor,” e.g., when used to refer to the entity that performs the compression operations, refers to the one or more processors that performs the compression operations and the term “decompressor,” e.g., when used to refer to the entity that performs the decompression operations, refers to the one or more processors that performs the decompression operations. In various examples, compression is performed by a processor such as a CPU (e.g., a processor 102), a GPU (e.g., an APD 116), or another processor. In various examples, decompression is performed by a processor such as a CPU (processor 102) or GPU (APD 116). In various examples a ray tracing pipeline 400, implemented on an APD 116, performs decompression in the course of obtaining primitives from a leaf node. In other words, in such examples, the ray tracing pipeline 400 obtains primitives from compressed data structures (as described elsewhere herein) upon arriving at a leaf node. In other examples, a rasterization based pipeline (e.g., a pipeline based on vertex shaders and pixel shaders) performs decompression on a compressed data structure storing primitives according to the techniques described herein, in order to process such primitives (e.g., in order to perform vertex shading with such primitives, and to otherwise process such primitives).

At step 1002, a compressor stores unique vertices into a compressed data structure. As described herein, a compressed data structure stores unique vertices and topology information that indicates how the vertices are interpreted as primitives. Each unique vertex is stored only once in the compressed data structure, as any duplicate use of a vertex is indicated (e.g., implicitly) by the topology information.

At step 1004, the compressor stores topology information which includes a subdivision type and a number of subdivisions. The subdivision type indicates the format of the implied geometry, and can be one of a wide variety of types, including triangle grid, quad grid, triangle loop, or Catmull-Clark, as well as other types not described herein. The number of subdivisions indicates the number of times that base geometry is subdivided to generate a final set of primitives. In an example, if this number is one, then base geometry is subdivided once to form the primitives. If this number is two, then the base geometry is subdivided to obtain intermediate resulting geometry and then the intermediate resulting geometry is further subdivided to obtain the final geometry represented by the compressed data structure. It should be understood that this subdivision type and number of subdivisions, taken together, indicates the manner in which the stored unique vertices are interpreted as triangles when decompressed.

At step 1006, a decompressor outputs vertex information for a primitive based on the unique vertices, the subdivision type, and the number of subdivisions. More specifically, to output any given primitive, the decompressor selects a set of vertices from the unique vertices that correspond to that primitive, where the selection is performed based on the subdivision type and number of subdivisions. In some examples, any given combination of subdivision type and number of subdivisions defines a set of triangles, each identified by an index. Each such triangle corresponds to a different set of unique vertices. The decompressor is capable, either algorithmically, through use of a lookup table, or through other means, to identify the appropriate vertices given the combination of subdivision type and number of subdivisions. It should be understood that even with use of a lookup table in this manner, the correspondence between triangle and sets of vertices is not stored in the compressed data structure itself, but would be stored for example by the decompressor as commonly used information. Example correspondences between triangle indices and vertex identifiers are shown with respect to FIGS. 7A-9B (for example, triangle 3 in FIG. 7A comprises vertices V4, V5, and V6. Again, this correspondence is not stored in the compressed data structure itself but is understood by the decompressor based on the combination of subdivision type and number of subdivisions.

Any technically feasible system can request the decompressor to provide such decompressed triangles from a compressed data structure. In various examples, the ray tracing pipeline obtains such primitives upon arriving at a leaf node and performs intersection tests and other operations using such primitives. In other examples, a rasterization pipeline obtain triangles from a compressed data structure and performs rendering operations such as performing vertex shading, pixel shading, and outputting to a render target. Operations other than rendering using ray tracing or rasterization could be used as well. For example, modeling software could store geometry in a compressed format and compress and decompress such geometry for storage and display as needed. Any other software or hardware could perform operations using such compressed geometry.

It should be understood that although the example geometries provided herein show one base primitive and all primitives that result from the subdivision of that base primitive being stored in a single compressed data structure, it is not necessary for that to be the case. Any particular compressed data structure can store a range of primitives for which vertices are actually stored in the compressed data structure. For example, one compressed data structure indicating a loop triangle subdivision with two subdivisions (e.g., FIG. 7B) can indicate that triangles 5-12 are stored in the compressed data structure. Alternatively, one compressed data structure can indicate which vertices, by number, are stored in the compressed data structure. Where vertices for a triangle are located in two different compressed data structure, the decompressor obtains those vertices from the two different compressed data structures to generate the triangle. It is also possible for primitives to have vertices stored in different compressed data structures, where such different compressed data structures are stored with different geometry subdivision types or where one compressed data structure indicates no geometry subdivision type and thus explicitly indicates vertex indices (e.g., as with FIG. 5). In such examples, the decompressor obtains the vertices from the different compressed data structures and reconstructs triangles.

Although the term “triangle” or “quad” is sometimes used here, this term can be replaced with “primitive” for similar, though broader meaning. The term “primitive” refers generally to geometric objects such as triangle, quad, or other geometry object.

In some examples, all compressed data structures have the same size, or have one of a limited number of sizes (e.g., 2 or 4 different sizes). For this reason, the use of a subdivision type indication and number of subdivisions allows for more room for vertices in any given compressed data structure.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the accelerated processing device 116, the scheduler 136, the compute units 132, the SIMD units 138, local data store 137, APD memory 139, ray tracing pipeline 300, ray generation shader 302, acceleration structure traversal stage 304, any hit shader 306, hit or miss unit 308, closest hit shader 310, or miss shader 312, may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
obtaining a first primitive from a compressed data structure based on topology information that indicates a subdivision type stored in the compressed data structure; and
performing rendering operations utilizing the first primitive.

2. The method of claim 1, wherein the topology information also indicates a number of subdivisions.

3. The method of claim 1, wherein the subdivision type comprises one of a triangle grid, a quad grid, a loop subdivided triangle, a Catmull-Clark subdivided triangle, or a Catmull-Clark subdivided quad.

4. The method of claim 1, wherein the compressed data structure stores vertex data for unique vertices.

5. The method of claim 4, wherein the subdivision type implicitly indicates a correspondence between triangles and the unique vertices.

6. The method of claim 1, further comprising a second primitive having vertices stored in both the compressed data structure and a second compressed data structure.

7. The method of claim 1, wherein the rendering operations comprise one of performing rasterization based rendering or performing ray tracing based rendering.

8. The method of claim 1, further comprising compressing a plurality of primitives including the first primitive to generate the compressed data structure.

9. The method of claim 8, wherein the compressing comprises storing unique vertices and the topology information into the compressed data structure.

10. The method of claim 1, wherein the first primitive is stored in a fixed-point format.

11. A system, comprising:
a memory storing a compressed data structure; and
a processor configured to:
obtain a first primitive from the compressed data structure based on topology information that indicates a subdivision type stored in the compressed data structure; and
perform rendering operations utilizing the first primitive.

12. The system of claim 11, wherein the topology information also indicates a number of subdivisions.

13. The system of claim 10, wherein the subdivision type comprises one of a triangle grid, a quad grid, a loop subdivided triangle, a Catmull-Clark subdivided triangle, or a Catmull-Clark subdivided quad.

14. The system of claim 10, wherein the compressed data structure stores vertex data for unique vertices.

15. The system of claim 14, wherein the subdivision type implicitly indicates a correspondence between triangles and the unique vertices.

16. The system of claim 10, wherein a second primitive has vertices stored in both the compressed data structure and a second compressed data structure.

17. The system of claim 10, wherein the rendering operations comprise one of performing rasterization based rendering or performing ray tracing based rendering.

18. The system of claim 10, wherein the processor is further configured to compress a plurality of primitives including the first primitive to generate the compressed data structure.

19. The system of claim 18, wherein the compressing comprises storing unique vertices and the topology information into the compressed data structure.

20. A non-transitory computer-readable medium storing instructions that, when executed by a processor, cause the processor to perform operations comprising:
obtaining a first primitive from a compressed data structure based on topology information that indicates a subdivision type stored in the compressed data structure; and
performing rendering operations utilizing the first primitive.
